(19) United States
(12) Patent Application Publication
(10) Pub. No.: US 2017/0351075 A1
(43) Pub. Date: Dec. 7, 2017

(54) ADJUSTABLE LIGHT SOURCE DEVICE FOR A STEREOSCOPIC SURGICAL MICROSCOPE

(71) Applicant: Visionnaire Medtech Co., Ltd., Changhua City (TW)

(72) Inventors: Ming-Chou Ku, Changhua County (TW); Kai-Che Liu, Changhua County (TW); Kun-Wei Lin, Changhua County (TW); Ivan Ku, Changhua County (TW); Shih-Chi Chan, Changhua County (TW); Tong-Wen Wang, Changhua County (TW); I-Chun Lee, Changhua County (TW)

(21) Appl. No.: 15/172,773

(22) Filed: Jun. 3, 2016

(51) Int. Cl. G02B 21/06; F21V 23/00; G02B 21/00; G02B 21/22; G02B 21/02; F21W 131/205

(52) U.S. Cl. CPC G02B 21/06; G02B 21/22; G02B 21/02; F21V 23/005; G02B 21/0012; F21W 2131/205

(57) ABSTRACT

An adjustable light source device for a stereoscopic surgical microscope has a circuit board and multiple light sources. The circuit board is mounted in an outer casing of the stereoscopic surgical microscope and is electrically connected to a host computer of the stereoscopic surgical microscope. The light sources are electrically mounted on the circuit board at spaced intervals around two objective lenses of the stereoscopic surgical microscope and extend out of the outer casing. Each one of the light sources has a wavelength different from wavelengths of the other light sources and is controlled to emit light by an operating set of the stereoscopic surgical microscope via a program processing interface of the host computer sending signals to the circuit board. The adjustable light source device can emit lights with different wavelengths to enable the stereoscopic surgical microscope to capture clearer images for various surgical divisions.

### BACKGROUND OF THE INVENTION

### 1. Field of the Invention

The present invention relates to a light source device, and more particularly to an adjustable light source device for a stereoscopic surgical microscope that can provide light sources of different wavelengths to enable the stereoscopic surgical microscope to capture clearer images, can enable users to see the tissue disease and the structure of blood vessels clearly to analyze the lesion accurately and to reduce the probability of cutting the blood vessels or nerves during surgery, and can be applied to various surgical divisions without purchasing a variety of light source devices of different wavelengths.

### 2. Description of Related Art

With the rapid development of technology, there is significant progress in medical technology, and a 3D stereoscopic image technology is a very popular topic in the medical technology and can be applied in the clinical surgery. Then, the doctors can cut, remove or treat organs or tissues of complex and varied thicknesses, and this is a great help for the inspection and treatment of diseases. So the doctors can perform surgery more easily and accurately to significantly enhance the quality of medical treatment. Therefore, various types of 3D stereoscopic surgical microscopes are presented in the market currently.

A conventional 3D stereoscopic surgical microscope such as Leica UTL 500 can provide 3D images to the doctors for surgery or treatment, but a light source device of the conventional 3D stereoscopic surgical microscope uses a visible light or a light with a single wavelength for certain divisions such as neurosurgery, etc. As the visible light or the light with a single wavelength can only enable the conventional 3D stereoscopic surgical microscope to obtain a 3D image at a specific position of a human body and cannot provide a clear 3D image of the tissue disease and the structure of blood vessels at some positions of the human body, this will influence the fluency and efficiency of surgery and cannot provide a preferred medical effect to the patient. In addition, different surgical divisions must buy light source devices of different wavelengths to use, and this will relatively limit the practicability of the conventional 3D stereoscopic surgical microscope.

To overcome the shortcomings, the present invention provides an adjustable light source device for a stereoscopic surgical microscope to mitigate or obviate the aforementioned problems.

### SUMMARY OF THE INVENTION

The main objective of the present invention is to provide an adjustable light source device for a stereoscopic surgical microscope that can provide light sources of different wavelengths to enable the stereoscopic surgical microscope to capture clearer images, can enable users to see the tissue disease and the structure of blood vessels clearly to analyze the lesion accurately and to reduce the probability of cutting the blood vessels or nerves during surgery, and can be applied to various surgical divisions without the need to purchase a variety of light source devices of different wavelengths.

The adjustable light source device for a stereoscopic surgical microscope in accordance with the present invention has a circuit hoard and multiple light sources. The circuit board is mounted in an outer casing of the stereoscopic surgical microscope and is electrically connected to a host computer of the stereoscopic surgical microscope. The light sources are electrically mounted on the circuit board at spaced intervals around two objective lenses of the stereoscopic surgical microscope and extend out of the outer casing. Each one of the light sources has a wavelength different from wavelengths of the other light sources and emits light under control by an operating set of the stereoscopic surgical microscope via a program processing interface of the host computer sending signals to the circuit board. The adjustable light source device can emit lights with different wavelengths to enable the stereoscopic surgical microscope to capture clearer images for various surgical divisions.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable light source device for a stereoscopic surgical microscope in accordance with the present invention, mounted on a stereoscopic surgical microscope;

FIG. 2 is an enlarged perspective view of the adjustable light source device in FIG. 1;

FIG. 3 is an enlarged bottom view of the adjustable light source device in FIG. 2;

FIG. 4 is an enlarged bottom view of a first arrangement of the adjustable light source device in FIG. 2;

FIG. 5 is a block diagram of the adjustable light source device in FIG. 1;

FIG. 6 is a wavelength distribution diagram of different lights in accordance with the present invention; and

FIG. 7 is an enlarged bottom view of a second arrangement of the adjustable light source device in FIG. 2.

### DETAILED DESCRIPTION OF THE PREFERRED EMBODIMENT

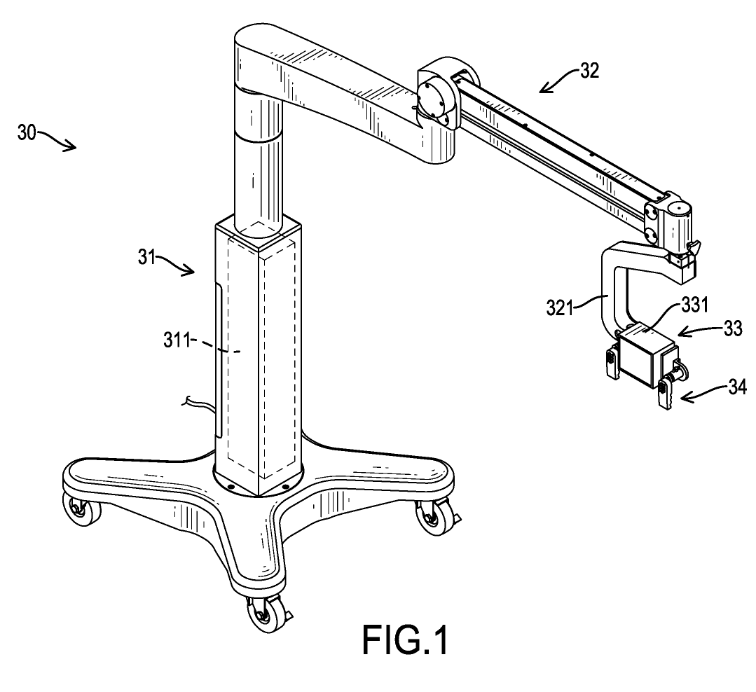

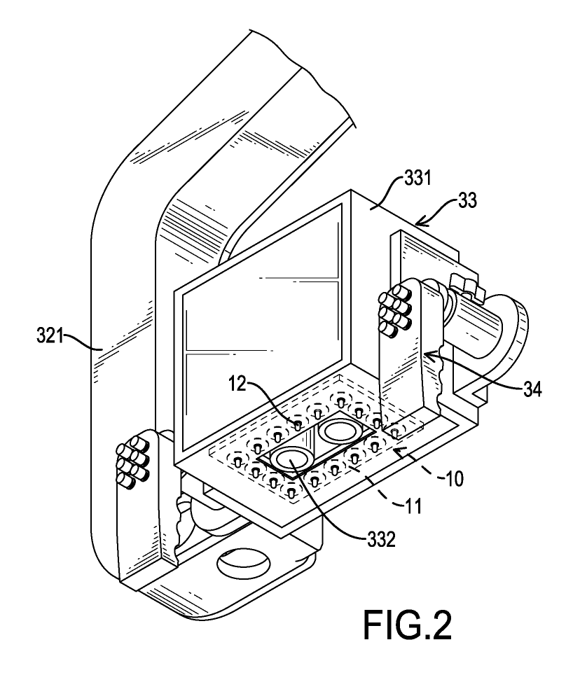

With reference to FIGS. 1 to 3 and 5, an adjustable light source device 10 in accordance with the present invention is mounted on a stereoscopic surgical microscope 30 and has a circuit board 11 and multiple light sources 12.

The stereoscopic surgical microscope 30 has a body 31, a robot set 32, an image set 33, and an operating set 34. The body 31 has a host computer 311. The host computer 311 is mounted in the body 31 and has a program processing interface. The robot set 32 is securely connected to the body 31 and has a rotating arm 321. The rotating arm 321 is rotatably connected to the body 31.

The image set 33 is securely connected to the rotating arm 321, is electrically connected to the body 31, and has an outer casing 331 and two objective lenses 332. The outer casing 331 is securely connected to the rotating arm 321. The two objective lenses 332 are mounted in the outer casing 331 at a spaced interval, are electrically connected to the host computer 311, and each one of the objective lenses 332 has a filter mounted in the objective lens 332. The filter can provide a narrow beam image to the corresponding objective lens 332 to enable a light source with a specific wavelength to pass through the filter. The operating set 34 is connected to the robot set 32 and is electrically connected to the body 31 and the image set 33.

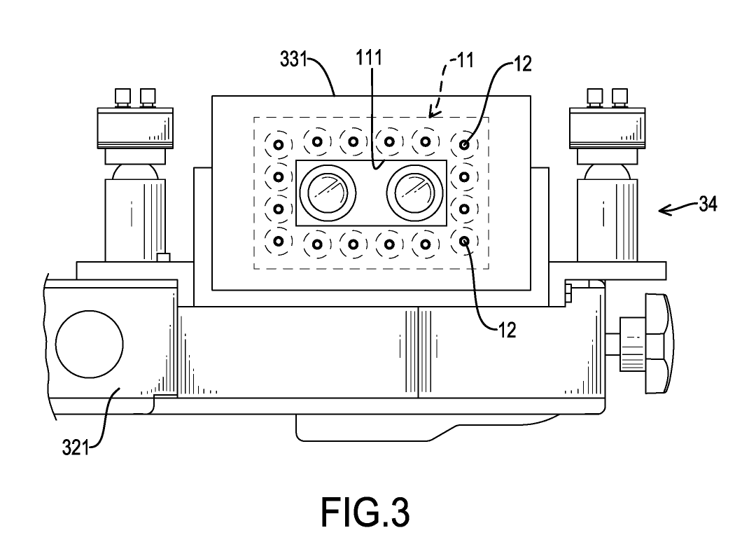

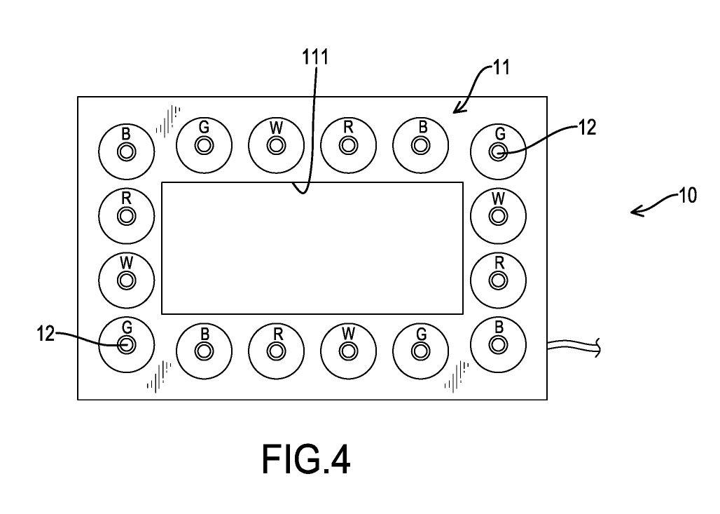

With further reference to FIGS. 3 and 4, in a first arrangement of the adjustable light source device 10 in accordance with the present invention, the adjustable light device 10 is securely mounted on the image set 33 of the stereoscopic surgical microscope 30.

The circuit board 11 is mounted in the outer casing 331 below the two objective lenses 332, is electrically connected to the host computer 311 and has a front side, a rear side, a middle, and a through hole 111. The through hole 111 may be rectangular and is formed through the rear side and the front side of the circuit board 11 at the middle of the circuit board 11 to enable the two objective lenses 332 to extend through the circuit board 11.

The light sources 12 are electrically mounted on the front side of the circuit board 11 at spaced intervals around the two objective lenses 332 and extend out of the outer casing 331. Preferably, the adjustable light source device 10 has sixteen light sources 12 mounted on the circuit board 11 at spaced intervals around the through hole 111 of the circuit board 11. In addition, each one of the light sources 12 is a light-emitting diode (LED).

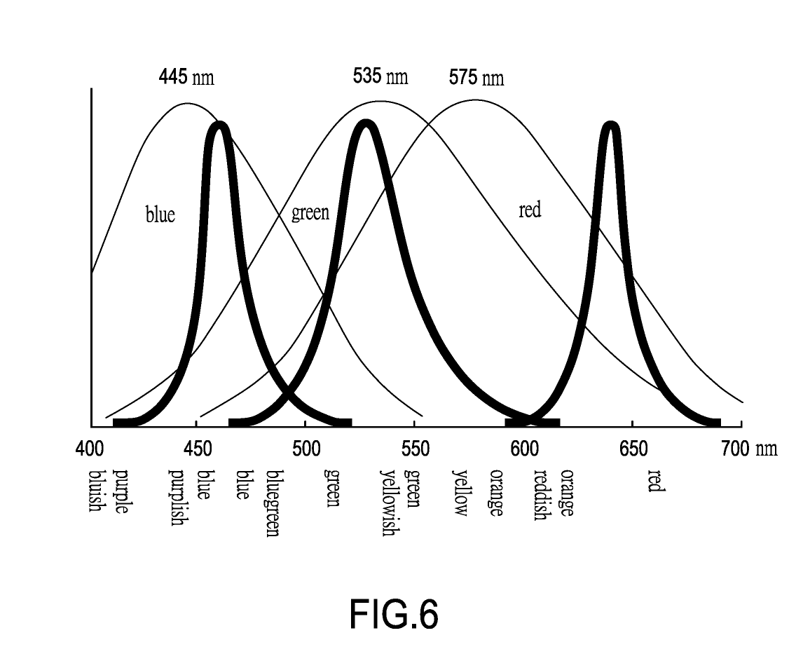

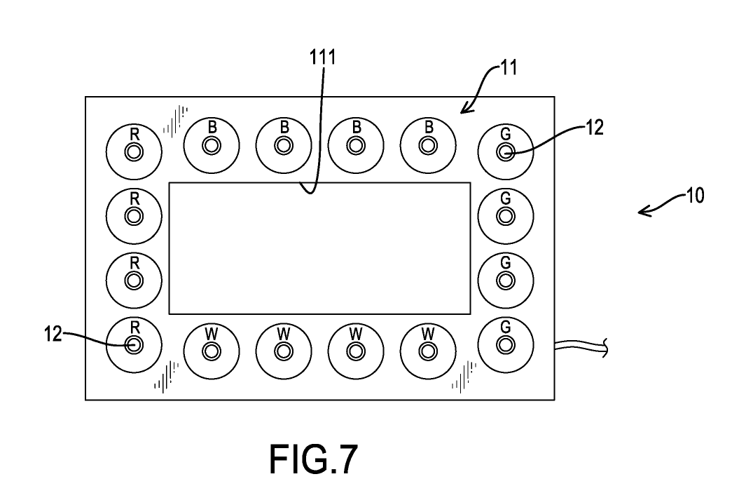

Furthermore, with reference to FIG. 6, the light sources 12 of the adjustable light source device 10 of the present invention can provide four different wavelengths, respectively blue light, green light, white light, and infrared light. A wavelength of the blue light is 415 nanometers, a wavelength of the green light is 540 nanometers, a wavelength of the white light is from 445 to 475 nanometers, and a wavelength of the red light is 850 nanometers. The light sources 12 with four different wavelengths are mounted on the circuit board 11 at spaced intervals according to a sequence of blue light, green light, white light, and infrared light. When the wavelength of light is longer, the light has a higher penetration, which means lights of different wavelengths have different penetration depths, wherein the infrared light penetrates the deepest, followed by the green light, and the blue light is the most shallow. Furthermore, when the blue light is used with the green light, the blue-green light allows each one of the objective lenses 332 to form a narrow beam image (NBI), and the infrared light is used to irradiate on the blood vessels to enable the blood vessels to form a black image, and the blood vessels may be effectively highlighted on the image, and the white light is used to provide an auxiliary lighting function. Additionally, with reference to FIG. 7, in a second arrangement of the adjustable light source device 10 in accordance with the present invention, the light sources 12 with the same wavelength are mounted on a same side of the circuit board 11 at spaced intervals.

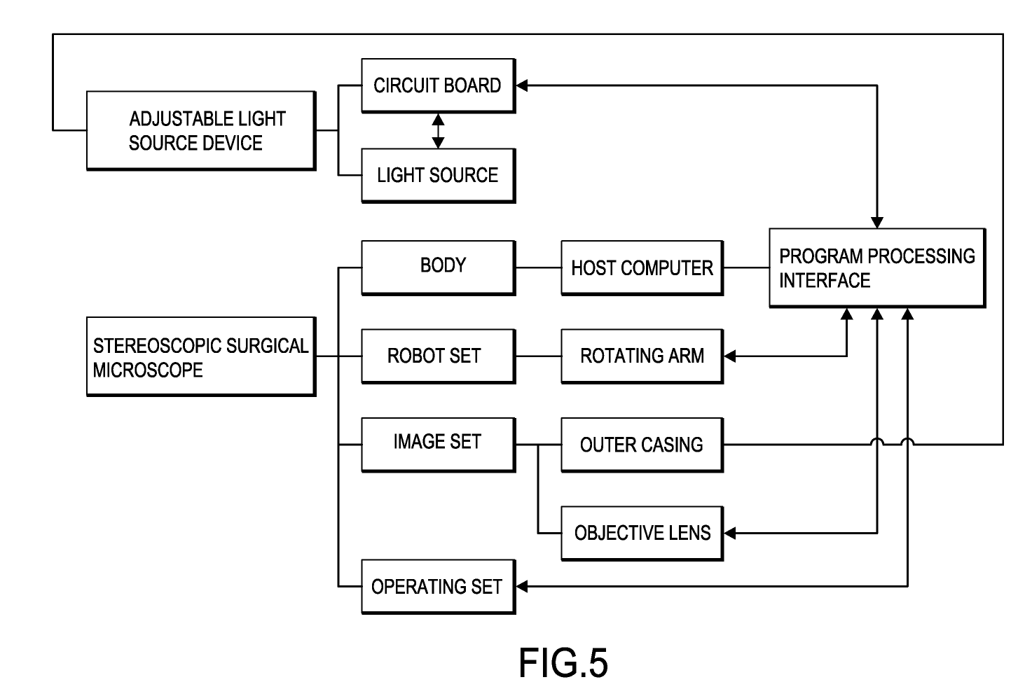

In use, with reference to FIGS. 1 and 5, when a doctor wants to perform surgery or treatment on organs or tissues of a human body by the stereoscopic surgical microscope 30, the body 31 of the stereoscopic surgical microscope 30 is moved close to the human body to enable the two objective lenses 332 of the image set 33 that is mounted on the rotating arm 321 to move over the human body. Then, the two objective lenses 332 can capture images of the human body by controlling the operating set 34, and the captured images are transferred to the host computer 311 of the body 31, and the infrared light may penetrate into the deepest of organs or tissues of the human body to show dark and larger blood vessels, and the blue light may penetrate into the shallowest of organs or tissues of the human body to show red capillary. The penetration depth of the green light is between the penetration depths of the infrared light and the blue light.

Then, the user may control the penetrations of the infrared light, the green light, and the blue light to strengthen the features of images. The hemoglobin in the mucosal is the main material to absorb a visible light and shows the most obvious absorbing effect for the blue light with a wavelength of 415 nanometers and the green light with a wavelength of 540 nanometers wavelength. Thus, the blood vessels will appear dark under the narrow beam image (NBI) technology and this can provide a strong contrast to the captured images. Furthermore, the wavelengths of blue light and green light are shorter than the wavelengths of white light and infrared light, the penetrations of blue light and green light are weak for the mucosal, and the blue light and the green light will be reflected by a surface of the mucosal, and this can show a structure of shallow microvasculars. Additionally, when the light sources 12 are strongly reflected by the surface of the mucosal, the surface morphology of the mucosal can be shown clearly. Therefore, the narrow beam image (NBI) technology can improve the contrast ratio of images, and this can allow users to observe the area or position of interest to show the structure of shallow microvasculars and the micro surface structure of the mucosal clearly.

Furthermore, the program processing interface of the host computer 311 can process and synthesize the captured images to form a 3D image. During the operating process, the user operates the operating set 34 to enable the program processing interface of the host computer 311 to send a signal to the circuit board 11, and at least one of the light sources 12 emits light to enable the two objective lenses 332 to capture images. Furthermore, the two objective lenses 332 can capture images at different positions by using the light sources 12 of different wavelengths. That is, the light sources 12 of different wavelengths can be arranged by the user to enable the two objective lenses 332 to capture images of nerves and organs or tissues with blood vessels at different positions. Then, the stereoscopic surgical microscope 30 can show clear 3D images to doctors, and doctors can see the tissue disease and the structure of blood vessels clearly to analyze the lesion accurately, and reduce the probability of cutting the blood vessels or nerves during surgery, and this can shorten time of surgery and the doctors can perform the surgery easily and accurately, significantly improving the quality of care surgery.

According to the above-mentioned technical features, the adjustable light source device 10 of the present invention is mounted on the stereoscopic surgical microscope 30, and the user or doctor can activate at least one of the light sources 12 to emit light by sending signals to the circuit board 11 via the program processing interface of the host computer 311. Then, the two objective lenses 332 can capture images of nerves and organs or tissues with blood vessels at different positions without the need to purchase a variety of light source devices of different wavelengths, and this can significantly enhance the medical practicability of the stereoscopic surgical microscope 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable light source device for a stereoscopic surgical microscope having a body with a host computer, a robot set securely connected to the body with a rotating arm, an image set securely connected to the rotating arm, electrically connected to the body and having an outer casing securely connected to the rotating arm and two objective lenses mounted in the outer casing at a spaced interval, electrically connected to the host computer, and each one of the objective lenses having a filter mounted in the objective lens to provide a narrow beam image to the objective lens, and an operating set connected to the robot set and electrically connected to the body and the image set, and the host computer having a program processing interface, and the adjustable light source device securely mounted on the image set of the stereoscopic surgical microscope and having:
a circuit board mounted in the outer casing below the two objective lenses and electrically connected to the host computer; and
multiple light sources electrically mounted on the circuit board at spaced intervals around the two objective lenses, extending out of the outer casing, and each one of the light sources having a wavelength different from wavelengths of other light sources and emitting light by an operation of the operating set to send signals to the circuit board via the program processing interface of the host computer.

2. The adjustable light source device as claimed in claim 1, wherein the circuit board has
a front side;
a rear side;
a middle; and
a through hole formed through the rear side and the front side of the circuit board at the middle of the circuit board to enable the two objective lenses to extend through the circuit board.

3. The adjustable light source device as claimed in claim 2, wherein the adjustable light source device has sixteen light sources mounted on the circuit board at spaced intervals around the through hole of the circuit board.

4. The adjustable light source device as claimed in claim 3, wherein the light sources of the adjustable light source device provide four different wavelengths, respectively blue light, green light, white light, and infrared light.

5. The adjustable light source device as claimed in claim 4, wherein the light sources with four different wavelengths are mounted on the circuit board at spaced intervals according to a sequence of blue light, green light, white light, and infrared light.

6. The adjustable light source device as claimed in claim 4, wherein the light sources with the same wavelength are mounted on a same side of the circuit board at spaced intervals.

7. The adjustable light source device as claimed in claim 1, wherein each one of the light sources is a light-emitting diode.

8. The adjustable light source device as claimed in claim 2, wherein each one of the light sources is a light-emitting diode.

9. The adjustable light source device as claimed in claim 3, wherein each one of the light sources is a light-emitting diode.

10. The adjustable light source device as claimed in claim 4, wherein each one of the light sources is a light-emitting diode.

11. The adjustable light source device as claimed in claim 5, wherein each one of the light sources is a light-emitting diode.

12. The adjustable light source device as claimed in claim 6, wherein each one of the light sources is a light-emitting diode.
